(19) United States
(12) Patent Application Publication
(10) Pub. No.: US 2014/0188674 A1
(43) Pub. Date: Jul. 3, 2014

(54) METHOD, SYSTEM AND COMPUTER PROGRAM FOR PROVIDING MULTILATERAL DEBT NETTING AND PAYMENT SERVICES FOR ENTERPRISES

(71) Applicant: Debt Lean, SL, Elgoibar (ES)

(72) Inventors: Miguel Ángel Carrera Astigarraga, Elgoibar (ES); Lander González Larrea, Elgoibar (ES); Iker de los Rios Amezua, Madrid (ES); Javier Carrascal Sanz, Madrid (ES); Sergio Chalbaud Lezama-Leguizamón, Madrid (ES)

(73) Assignee: Debt Lean, SL, Elgoibar (ES)

(21) Appl. No.: 14/143,345

(22) Filed: Dec. 30, 2013

Related U.S. Application Data
(60) Provisional application No. 61/748,517, filed on Jan. 3, 2013.

(51) Int. Cl. G06Q 40/00

(52) U.S. Cl. CPC G06Q 40/12
USPC 705/30

(57) ABSTRACT

A multilateral netting operation is configured for receiving, via at the at least one computing device, data defining two or more financial positions from a plurality of netting participants. This data is normalized by at least one computing device to define two or more comparable financial positions. The comparable financial positions are analyzed, by at least one computing device, to define one or more netting cycles. The netting cycles are then executed to cancel or net at least a portion of the comparable financial positions.

### TECHNICAL FIELD

The present disclosure relates generally to online and offline systems, methods and computer programs for offsetting debt positions, and in particular, to systems, methods and computer programs adapted for multilaterally netting debt positions throughout multiple tiers of a supply chain, including determining and issuing multilateral payment transactions.

### BACKGROUND

Current technology, methods and solutions do not enable enterprises to optimize their balance sheets in a manner that minimizes cash usage, while at the same time addressing funding needs. Indeed, existing balance sheet management systems and methods try to solve the mismatch between enterprises' credit and debit positions by simply borrowing additional funds (e.g., from banks or other financial institutions) and/or depleting their own cash reserves. Although such tactics may be helpful in helping enterprises avoid defaulting on their obligations, they are cash intensive and oblige the enterprises to take on debt and/or risk their cash reserves, even in cases where the enterprises are owed more than they themselves owe.

To illustrate, some services generally offered by banks and financial institutions, such as “Invoice Discounting,” offer a creditor the possibility of receiving an advance on its collections so that it has the funds to pay its obligations. Another alternative, known as “Reverse Factoring,” is similar to Invoice Discounting but the initiative is triggered by a debtor (e.g., the ordering party or client) who chooses which of its obligations (to the creditor) it will allow to be paid earlier by the financial institution. And then, the creditor (e.g., supplier) will himself choose which of these obligations will need to be paid by the factor. However, these alternatives are very expensive and inefficient for enterprises.

Accordingly, there is a need for methods and systems by which enterprises are able to effectively leverage their receivables and other ‘incoming’ obligations to dispose of and satisfy their debt and other ‘outgoing’ obligations, all in a manner that conserves the enterprises' cash while at the same time minimizing the need for external funding.

### SUMMARY

The present disclosure relates generally to methods, systems and computer programs configured for multilaterally netting financial positions. To that end, the claims describe methods, systems and computer programs for receiving, via at the at least one computing device, data defining two or more financial positions from a plurality of netting participants. This data may then be normalized by at least one computing device to define two or more comparable financial positions. The comparable financial positions may then be analyzed, by at least one computing device, to define one or more netting cycles. The netting cycles may then be executed to cancel or net at least a portion of the comparable financial positions.

### BRIEF DESCRIPTION OF THE DRAWINGS

The foregoing summary and the following detailed description are better understood when read in conjunction with the appended drawings. Exemplary embodiments are shown in the drawings, however, it is understood that the embodiments are not limited to the specific methods and instrumentalities depicted herein. In the drawings:

FIG. 1 is an exemplary multilateral netting operation according to the present disclosure;

FIG. 1A is an exemplary financial position standardization sub-operation according to the present disclosure;

FIG. 1B is an exemplary netting value determination sub-operation according to the present disclosure;

FIG. 1C is an exemplary multilateral netting sub-operation according to the present disclosure;

FIG. 1D is an exemplary incomplete netting cycle closing sub-operation according to the present disclosure;

FIG. 2 is an exemplary supply chain finance (SCF) solution according to the present disclosure; and

FIG. 3 is another exemplary SCF solution according to the present disclosure.

### DETAILED DESCRIPTION

At a high level, the present disclosure creates a new peer-to-peer debt market where multiple enterprises can join and provide the details of their multiple outstanding debts positions. The debt positions may then be analyzed to identify and determine the interdependencies between the debt positions (and the participating enterprises). As a result of this analysis, multilateral netting cycles may be defined to multilaterally net the debt positions, thereby reducing the total debt in the system, while at the same time minimizing the amount of actual cash that has to be expended to satisfy the debt positions. In addition to such netting services, the present disclosure may also provide payment services that enable users (e.g., enterprises) to reduce or eliminate the debt positions they are carrying on their books.

By implementing the solution described herein, participating enterprises are able to compensate their invoices (credits) and expenses (debts) and therein reduce their funding needs and financial costs. This way, the solution reduces credit risk with clients and simplifies cash management, as well as reduces the enterprises overall operating costs.

As will be evident from the following description, the present disclosure provides a solution that (among other features and functions):
a. automatically normalizes different financial positions, including positions defined by multiple-payments, for purposes of analyzing and comparing the financial positions;
b. automatically analyzes the interdependencies between financial positions of multiple participating enterprises, and defines one or more multilateral netting cycles (involving multiple enterprises and financial positions) for optimizing (or adjusting as desired) the balance sheet structure of the enterprises; as an example, the multilateral netting cycles may be configured to reduce the total debt and debt positions in the system, while at the same time reducing and/or eliminating credit risk and/or the actual cash/funding needed to satisfy the debt;
c. automatically generates one or more payment proposals that minimize the amount of cash needed to reduce or eliminate debt positions, and optionally issue payments to satisfy outstanding debt positions;
d. automatically transfer funds as debits or credits between enterprises allowing them to close incomplete multilateral netting cycles;
e. automatically manages all downstream processing during the life of the different receivable and payable financial positions of enterprises' balance sheets, including generating required legal documentation and electronic files that feed enterprises' internal systems (e.g., Enterprise Resource Planning (ERP) systems); and
f. other features and functions that will be apparent from the following detailed description.

For purposes of this disclosure, certain terms used herein may be attributed the following definitions:

Average Deposit Rate: the average interest rate paid by financial institutions to their clients for depositing money into an account at that financial institution.

Bilateral Netting: an arrangement between two counterparties that creates a single obligation by compensating different individual contracts or debts. For example, consider two counterparties (Enterprise 1 and Enterprise 2) with obligations towards each other having netting values X and Y, respectively. Bilaterally netting these obligations will compensate at least a portion of the obligations which may result in a single remaining obligation between Enterprise 1 and Enterprise 2, the payment (or satisfaction) of which will completely obviate all obligations between them.

Complete Multilateral Netting Cycle: a multilateral netting cycle that involves a group of enterprises having one or more financial positions between them, such that each enterprise in the group holds at least one debt position against at least one other enterprise in the group. As an example, consider a multilateral netting group comprised of Enterprises 1-4. Each such enterprise holds a debt position against at least one other enterprise in the group. Enterprise 2 holds a debt position against Enterprise 3, Enterprise 3 holds a debt position against Enterprise 4, Enterprise 4 holds a debt position against Enterprise 1 and Enterprise 1 holds a debt position against Enterprise 2.

Discounted Value: a notional value of a financial position (e.g., debt position), adjusted by a Discount Factor (defined below) of its payment date (e.g., typically maturity date). This value may be calculated as the notional value*Discount Factor (this Discount Factor may be calculated, for example, according to Equation 1 below, where “days” may be the days left to maturity and where “discount rate” refers to a predetermined, calculated or negotiated discount rate. Once the maturity date passes, the Discounted Value may be the same as the notional value, as the Discount Factor used to its calculation will be one.

Discount Factor: the factor that may be used to calculate the Discounted Value, represented by Equation 1 below:

$$\frac{1}{[ ( \frac{days}{35} ) \times ( 1 + discount rate ) ]} \qquad Equation 1$$

Incomplete Multilateral Netting Cycle: contrary to a Complete Multilateral Netting Cycle (defined above) an incomplete multilateral netting cycle involves a group of enterprises having one or more financial positions between them, however, at least one of the enterprises does not hold a debt position against any other enterprise in the group. As an example, consider a group of three enterprises: Enterprise 1, Enterprise 2 and Enterprise 3. Now consider the situation where Enterprise 1 holds a debt position with a netting value of NV X against Enterprise 2 and Enterprise 2 holds a debt position with a netting value of NV Y against Enterprise 3. However, Enterprise 3 does not hold a debt position against Enterprise 1 or 2.

Mathematical Algorithm: The Mathematical Algorithm, that allows the invention to generate complete and incomplete multilateral netting cycles, is based on using graph theory which is the study of graphs. Graphs are mathematical structures used to model pairwise relations between objects from a certain collection. A “graph” in this context is a collection of “vertices” or “nodes” and a collection of edges that connect pairs of vertices. As a node is the basic unit with which graphs are formed, the Netting Values automatically calculated by the invention or agreed by the enterprises though the system are the nodes (or sets of vertices and interlinked connectors) of the algorithm.

Money Transmitter Operator: an entity authorized to carry out payment services in a determined geographical area. These entities may be required to fulfill special capital requirements, depending on the number of payment services they want to provide.

Netted Notional: the notional (of financial positions as between parties) that has been netted (e.g., cancelled or offset) as a result of a multilateral netting operation in accordance with the present disclosure. Notably, debt positions may be partially netted, fully netted or compensated (e.g., via a payment transaction). Any portion of a notional value which has been netted may be deemed to have been paid, and the creditor and the debtor parties associated with the notional recognize this total or partial netting as a valid payment method.

Netting Services: services that include the process of searching, determining, defining, calculating or otherwise identifying one or more multilateral netting cycles, whether Complete or Incomplete Multilateral Netting Cycles, to achieve at least a partial or total cancellation of debt positions as between a group of enterprises.

Netting Value: a value that a financial position (e.g., debt position) represents for purposes of executing a multilateral netting operation. The Netting Value may be determined and/or adjusted using a Discounted Value, as defined above, and/or it may be negotiated between parties.

Payment Proposals: proposed payment amounts (of funds) offered to satisfy debt that may remain after completion of a netting operation in a multilateral netting cycle. In the case of an Incomplete Multilateral Netting Cycle (defined above), for example, a payment proposal may represent a payment to the debtor and creditor at each end of multilateral chain or cycle. Payment proposals may include an amount to pay (which may be lower than an original debt value) and the general conditions of the payment (e.g., whether commissions will be applied). If the appropriate parties agree, a payment according to the payment proposal may be executed (e.g., via a Money Transmitter Operator), thereby completely or partially satisfying debts in the Incomplete Multilateral Netting Cycle.

Payment Services: services including (without limitation) depositing and/or withdrawing funds to and/or from one or more accounts, issuing payment instruments, transmitting funds electronically, and related services. As noted above, Money Transmitter Operators may provide payment services.

Tentative Netting Value: the tentative value that a financial position (e.g., debt position) represents for purposes of executing a multilateral netting operation. Tentative Netting Values may be presented to one or more counterparties for approval, negotiation, adjustment and/or disapproval. An agreed-upon Tentative Netting Value may be deemed a Netting Value (defined above) that may be processed and utilized to execute Multilateral Netting Cycles and Incomplete Multilateral Netting Cycles. As an option, the Tentative Netting Value may be determined and/or adjusted according to any number of factors, including (without limitation) previous performance of a debtor, credit risk, previous negotiated values, a discretionary adjustment by a user, etc.

Value or Supply Chain: a collection or chain of enterprises operating in an industry with commercial relationships in order to deliver something valuable (product or service). Members of the value chain are each responsible for a particular task and/or service that adds value to the product or services passing through the chain. An example of a Supply Chain may include a Buyer Enterprise, a Tier 1 Supplier Enterprise and a Tier 2 Supplier Enterprise. For purposes of multilateral netting, this exemplary Supply Chain may utilize an Incomplete Multilateral Netting Cycle. This is because at least one participant (e.g., the Buyer Enterprise) does not hold any debt positions against any other participant in the group.

### Overview

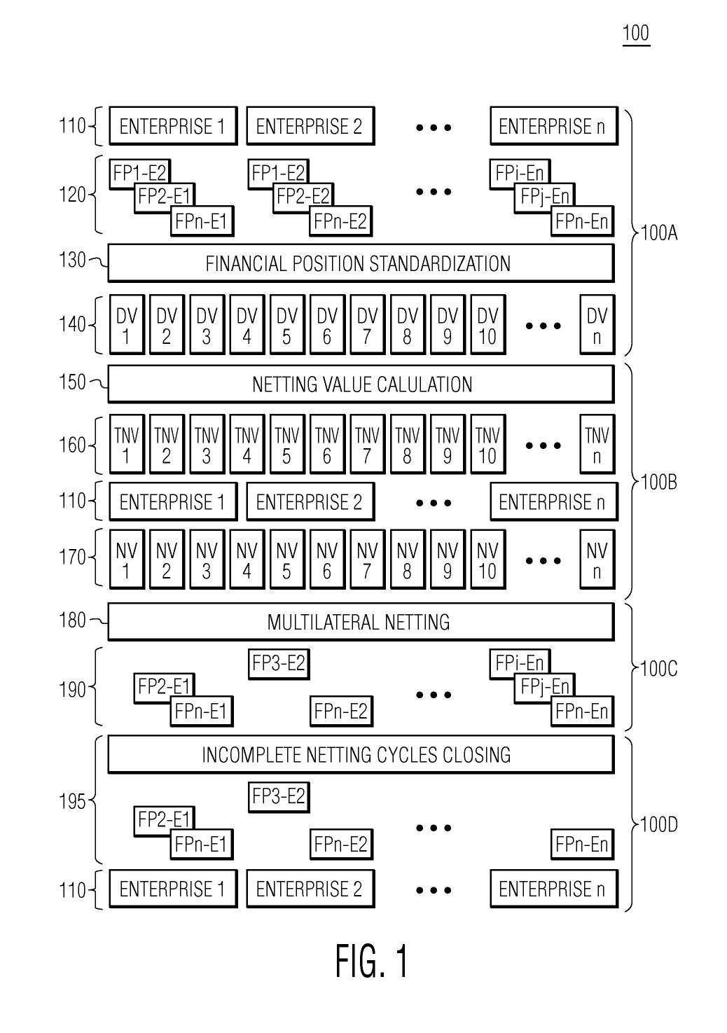

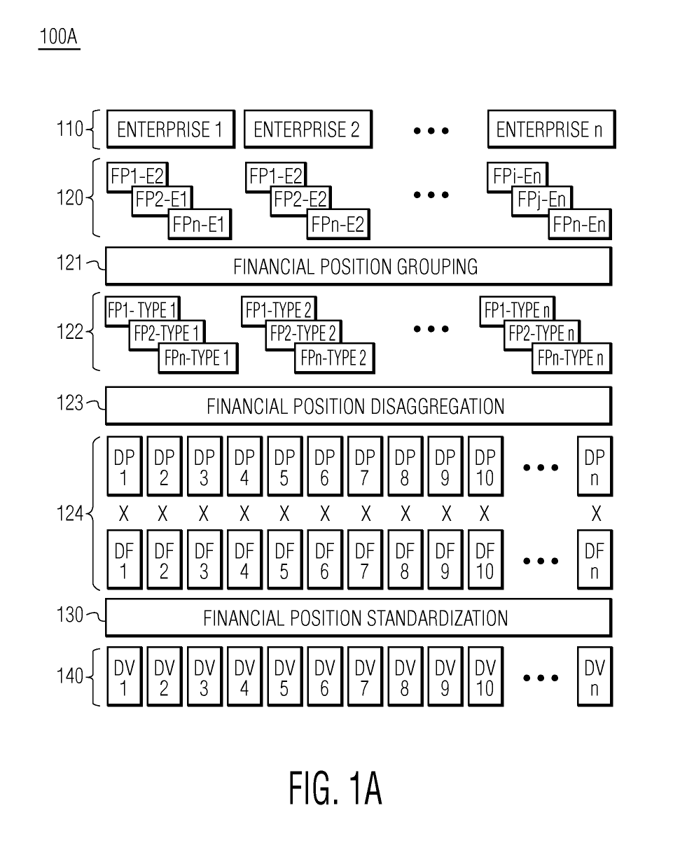

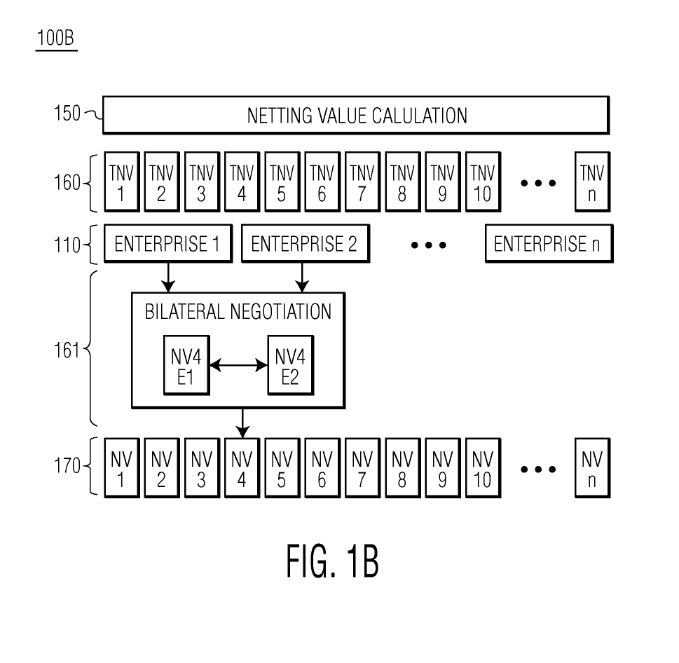

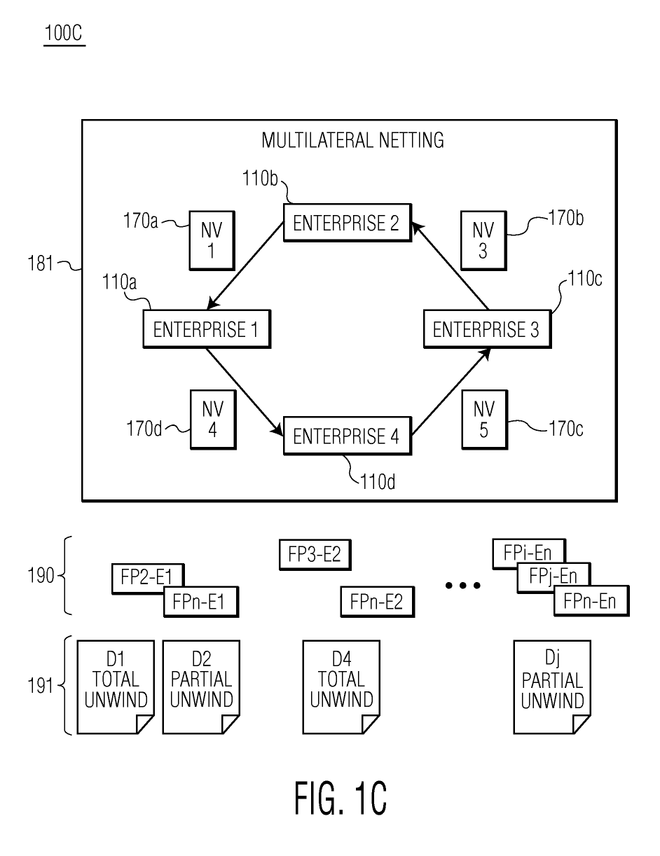

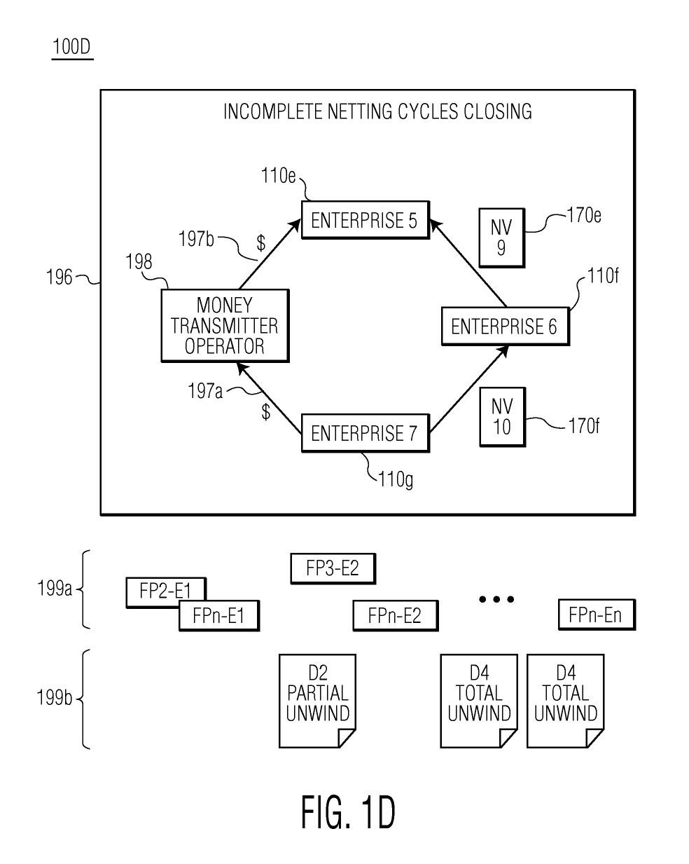

An overview of the present disclosure is described below in conjunction with FIG. 1 and FIGS. 1A-1D. FIG. 1 illustrates a high-level overview of an exemplary multilateral netting operation 100 according to the present disclosure. This multilateral netting operation 100 may be implemented as one or more of a computerized system, apparatus (e.g., computer device), a method, a computer program, and/or by or as any other appropriate means. For purposes of this illustration, the multilateral netting operation 100 may be divided into sub-operations 100A-100D, each of which may individually or collectively be configured for achieving a particular purpose or function. As such, the sub-operations 100A-100D may be generally referred to as follows: Financial Position Standardization 100A; Netting Value Determination 100B; Multilateral Netting 100C: and Incomplete Netting Cycle Closing 100D. Each of these sub-operations 100A-100D will be discussed in further detail below in conjunction with FIGS. 1A-1D, respectively.

Turning now to FIG. 1, a multilateral netting operation 100 according to an exemplary implementation of the present disclosure is shown. For purposes of this illustration, the entities participating in the multilateral netting operation 100 shall be referred to as enterprises. It should be understood, however, that any type of entity (e.g., person, corporation, bank, government, etc.) may be a party to and participate in the multilateral netting operation described herein.

In summary, the multilateral netting operation 100 standardizes 130 financial positions (e.g., debt positions) 120 of multiple participating enterprises 110 by receiving transaction details and parameters of the financial positions 120 from the respective enterprises 110. This standardization feature 130 essentially normalizes the financial positions 120 so that they are comparable. For example, this normalizing process may include determining a Discounted Value (DV) 140 for each of the financial positions.

Once the financial positions are standardized 110A, a Netting Value Determination 100B operation is performed. This involves, for example, calculating a Tentative Netting Value (TNV) 160 for each of the financial positions 120. In one aspect, the TNV's may be calculated according to a predetermined mathematical algorithm, they may be based on adjustments to the previously determined Discounted Values (e.g., based on performance of a debtor, etc.), and/or by other appropriate means. Optionally, once the Tentative Netting Values 160 are calculated, enterprises who are parties to financial positions (e.g., creditor and debtor of a particular financial position) may be given an opportunity to validate the TNV's 160 and/or institute a negotiation to determine whether the TNV's 160 need to be adjusted. Following the optional negotiation and validation, and after the TNV's 160 have been adjusted (if applicable), a final Netting Value (NV) 170 is determined for each financial position 120.

Next, a Multilateral Netting 1000 operation is performed generate multilateral netting cycles 180 and calculate a net position associated with each standardized financial position. These multilateral netting cycles may be determined according to a mathematical algorithm and/or by netting engine (embodied in a computing device), and they may be configured to maximize, minimize and/or optimize any number of desired parameters. For example, the multilateral netting cycles may be determined so as to maximize a Netted Notional of the financial positions, thereby reducing the debt of participating enterprises and the total debt in the system. As a result of generating the multilateral netting cycles 180, the NV's 170 of financial positions 120 may be consolidated into fewer single transactions 190.

In one exemplary embodiment, the multilateral netting operation 100 may include an Incomplete Multilateral Netting Cycle (IMNC) Closing 100D sub-operation. This sub-operation 100D may include generating IMNC's and clearing calculated payments (determined as a result of the IMNC's) 190 between the enterprises 110 at the end of these IMNC's. In one aspect, a mathematical algorithm and/or a netting engine embodied in a computing device may be configured to automatically calculate and generate Payment Proposals that, if accepted, would enable enterprises 110 participating in an IMNC to “close” said IMNC following a netting operation that does not completely offset or satisfy all of their respective financial positions. This may occur, for example, in a Supply Chain that includes at least three different enterprises. Accepted Payment Proposals may be executed via a Money Transmitter Operator which is authorized as an intermediary between enterprises (both debtor and creditor enterprises) to perform issue payments and to net financial positions included in the IMNC.

Turning now to FIG. 1A, an exemplary illustration of a Financial Position Standardization 100A sub-operation 100A is shown. A purpose or function of this sub-operation 100A may include standardizing various types and/or values of financial positions of a group of enterprises (e.g., corporate enterprises or any type of entities) participating in the multilateral netting operation 100.

As an initial step to this sub-operation 100A, the enterprises 110 participating in the multilateral netting operation 100 may begin by first providing details and parameters of their respective financial positions 120. These details and parameters may be provided, for example, into a computer system or platform configured to receive and process information in accordance with the present disclosure. As an option, the financial positions 120 may be aggregated into groups 121 by financial position type 122 (e.g., loans, commercial debt, etc.) to facilitate the standardization sub-operation 100A.

As another option, if any of the financial positions 120 themselves are defined as having multiple, planned payment obligations (e.g., such as a loan with periodic payments), these particular financial positions may be disaggregated 123 into their respective planned payment obligations, such that each planned payment obligation may itself be treated as a separate financial position for purposes of this standardization sub-operation 100A. In one embodiment, for each of these planned payment obligations, a Discount Factor for each payment date may be calculated using an Average Deposit Rate, which as defined above, represents interest paid out by financial institutions for their clients' deposits. This Discount Factor (DF) may then be multiplied by each original planned payment obligation (hereafter “debt payment” or “DP”) 124 to achieve comparable Discounted Values (DV) 140. A Discounted Value 140 may also be determined for the remaining financial positions 120 that are not themselves defined as having multiple, planned payment obligations. Notably, this standardization sub-operation 100A may be performed continually, periodically, randomly and/or at predetermined times as desired.

Turning now to FIG. 1B, an exemplary Netting Value Determination 100B sub-operation is shown. A purposes or function of this sub-operation 10013 may include determining a Netting Value associated with standardized financial positions. This sub-operation 100B generally includes automatically calculating 150 a Tentative Netting Value (TNV) 160 based on previously determined Discounted Values (DVs) 140 of the financial positions 120. As noted above, a TNV 160 may be determined by adjusting a DV 140 based on any number of factors, including (without limitation) on the previous performance of a debtor enterprise that is a party to the financial position for which the DV has been calculated. This adjustment may also be based on prior negotiations between the enterprises that are a party to said financial position.

Once the TNVs 160 are calculated, they may be presented to participating enterprises 110 validation and/or for optionally initiating a negotiation 161 to finalize the TNVs 160. This negotiation 161 may involve a bilateral negotiation between parties to a particular financial position during which changes are proposed and/or accepted until a final Netting Value (NV) that is acceptable to the parties is established.

Once the TNVs 160 are validated and accepted as a result of a negotiation 161, the TNV's are finalized and deemed final Netting Values (NVs) 170. These final NVs 170 may then be utilized to generate multilateral netting cycles (e.g., via a netting engine and/or a mathematical algorithm), as described below in connection with FIG. 1C.

FIG. 1C illustrates an exemplary Multilateral Netting 1000 sub-operation configured for generating multilateral netting cycles 180. As noted above, once the final NVs 170 are determined, they may be utilized to define one or more multilateral netting cycles, such as the exemplary multilateral netting cycle 181 depicted in FIG. 1C. This particular multilateral netting cycle 181 may be considered a Complete Multilateral Netting Cycle that includes four (4) enterprises 110a-d, each of which holds at least one debt position (having a Netting Value (NV) 170a-d) against at least one other enterprise 110a-d in the group. This multilateral netting cycle 181 may be configured to minimize, maximize or otherwise optimize any desired financial position parameter(s), such as the Netted Notional of the financial positions.

As a result of the multilateral netting cycle 181, the financial positions between the participating enterprises 110a-d may be may be consolidated into fewer single transactions 190. This may be accomplished, for example, by completely or partially unwinding or closing out of financial positions (e.g., debt positions) 191 that had been converted to a standardized financial position 100A having a Netting Value 170a-d. Optionally, this Multilateral Netting 100C sub-operation may further include generating amendments to the financial positions (e.g., to modify any outstanding debt resulting after the partial or complete unwinding of the financial positions). These amendments may include generating legal documents that oblige the enterprises 110a-d to recognize the total or partial unwinding or closing out of financial positions as a valid payment method.

Turning now to FIG. 1D, an exemplary Incomplete Netting Cycle Closing 100D sub-operation is shown. This sub-operation may include defining one or more Incomplete Multilateral Netting Cycles (IMNC) 196. This exemplary IMNC 196 includes three (3) enterprises 110e-g such that enterprise 5 (110e) holds a debt position having a Netting Value (NV) 170e of 9 against enterprise 6 (110f) and enterprise 6 (110f) holds a debt position having a Netting Value (NV) 170f of 10 against enterprise 7 (110g). Since enterprise 7 (110g) does not hold a debt position against any other enterprise in the group, this multilateral netting cycle may be considered an Incomplete Multilateral Netting Cycle 196. As with the Complete Multilateral Netting Cycle 181 discussed above, this Incomplete Multilateral Netting Cycle 196 may be configured to minimize, maximize or otherwise optimize any desired financial position parameter(s), such as the Netted Notional of the financial positions.

In addition to defining the IMNC 196, this Incomplete Netting Cycle Closing 100D sub-operation may include calculating one or more payment transactions 197a between one or more of the enterprises 110e, 110g at the end of the IMNC 196 to close the IMNC 196 (e.g., by compensating for any unnetted Netted Values remaining at the end of the IMNC 196). These payment transaction(s) 197a may include generating payment proposal(s) that are presented to the enterprises (e.g., debtor and creditor) 110e and 110g for validation. Once validated, instructions for generating and issuing the payment transaction(s) 197a may be provided to a Money Transmitter Operator 198 to execute the payment(s) 197b approved by the enterprises 110e and 110g. This Money Transmitter Operator 198 may be a part of the overall multilateral netting operation 100; or alternatively, such Money Transmitter Operator 198 may be a part of a separate payment platform that is unaffiliated with the multilateral netting operation 100. In either case, issuing the payment(s) 197b will serve to close the IMNC 196.

The netting and clearing process defined by the IMNC 196 may also include a total or partial unwinding or closing out 199b of the financial positions 199a (e.g., debt positions) that have been converted to standardized financial positions (e.g., via sub-operation 100A) having a Netting Value 170e-f. Optionally, this Incomplete Multilateral Netting Closing 100D sub-operation may further include generating amendments to the financial positions 199a (e.g., to modify any outstanding debt resulting after the partial or complete unwinding of the financial positions). These amendments may optionally include generating legal documents that oblige the enterprises 110e-f to recognize the total or partial unwinding or closing out 199b of financial positions 199a as a valid payment method.

The multilateral netting operation 100 described above (and throughout this disclosure), or portions thereof, may be implemented to provide a supply chain finance (SCF) solution that involves financial positions of entities (e.g., corporate enterprises) that form a supply chain. These entities may include, for example, a buyer entity, multiple supplier entities representing different tiers (e.g., Tier 1 supplier, Tier 2 supplier, and so on) and one or more external funding entities (e.g., bank, non-bank liquidity provider, etc.). Such a solution may be embodied as a web-based and hosted online solution that is easily accessible by members of the supply chain.

Features and advantages of such an SCF solution will be evident from the following illustrative examples, which include (without limitation): connecting buyer entities, supplier entities (multiple tiers) and funding entities into a single solution that optimizes working capital (i.e., avoid having to deplete their cash or take on additional debt to satisfy outstanding debt obligations) for all members of the supply chain; creating competition by involving multiple funding entities, both banking entities and non-banking alternatives, in the SCF solution which may ultimately result in better (e.g., lower) funding rates; providing multi-tier reverse factoring, which considers all financial positions at all levels of the supply chain and helps manage the flow of funds throughout the entire supply chain; enabling buyer entities to extend their payment terms by taking a leading role in the financing activities of all tiers of supplier entities in the supply chain; enabling buyer entities to offer early payments on their invoices, thereby discounting their payment obligations; and providing multilateral netting solutions between and amongst all members (and tiers) of the supply chain.

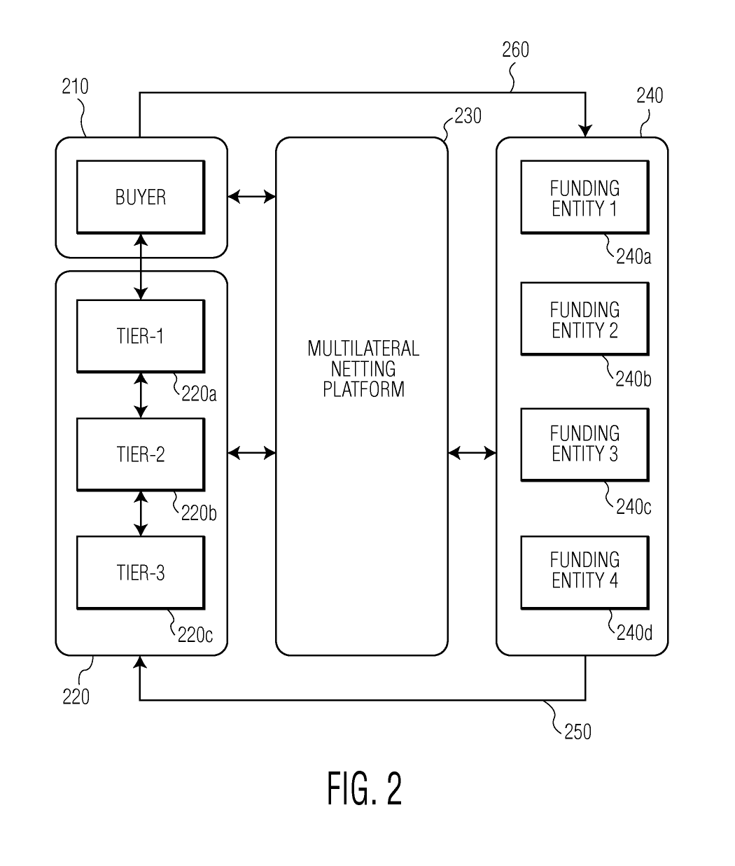

Turning now to FIG. 2, an exemplary SCF solution 200 according to the present disclosure is shown. This exemplary SCF solution 200 includes a buyer entity 210, multi-tiered supplier entities 220 and a multilateral netting platform 230. This solution also includes a plurality of funding entities 240, which may include both banking and non-banking liquidity providers 240a-d. As such, corporate entities may prefer this solution 200 because the multiple funding options 240 create competition and may ultimately lead to better funding rates. Notably, all entities 210, 220, 230 and 240 in this solution may each comprise one or more computing devices connected to each other via wired and/or wireless networks. As such, communications between the entities (included those summarized below) may involve electronic communications between computing devices.

As an initial step, the buyer entity 210 and/or the multilateral netting platform 230 may invite one or more of the suppliers entities 220 to join the SCF solution 200 and to agree to provide their respective pertinent financial position data and information to the multilateral netting platform 230. This may be accomplished, for example, by inviting the Tier 1 supplier entity 220a first, and the Tier 1 supplier 220a may in turn invite the remaining suppliers 220b-c to join; or all supplier entities 220 may be invited directly. Once the supplier entities 220 have agreed and joined, this will create a single SCF network 200 suitable for implementing a multilateral netting operation across the entire supply chain.

In operation, the supplier entities 220 may supply products to the buyer entity 210. As the products pass through the supply chain, each tiered supplier entity 220 adds value to the products. For example, the Tier 2 supplier 220b adds value to the products it receives from the Tier 3 supplier 220c, and the Tier 1 supplier 220a adds value to the products it receives from the Tier 2 supplier 220b, and so on.

As the products move up through the supply chain, each entity may generates and submit an invoice for the value it added to the products. For example, the Tier 3 supplier 220c may submit an invoice to the Tier 2 supplier 220b for the value it (the Tier 3 supplier 220c) added to the products. Similarly, the Tier 2 supplier 220b may submit an invoice to the Tier 1 supplier 220a for the value it added, and the Tier 1 entity may submit an invoice to the buyer entity 210 for the products.

Once the invoices are approved by the various entities, each entity 210, 220 may submit its accounts payable and/or receivable data and information (from the invoices) to the multilateral netting platform 230 for processing. The multilateral netting platform 230 may then normalize the data and information, define and execute one or more incomplete multilateral netting cycles, and generate one or more payment transaction proposals that may be provided to the buyer entity 210 and/or the supplier entities 220 for negotiation, adjustment and/or approval. Once the payment transaction proposal(s) are approved, payment transaction request(s) may be submitted to the funding entities 240. The funding entities 240 that approve of the requests may provide funding proposals for funding the payment transaction(s). These funding proposals may be provided (via the multilateral netting platform 230) to the buyer entity 210, who may in turn select which funding entity (or entities) 240 will fund the payment transaction(s). The selected funding entity(ies) 240 may then issue the payment transaction(s) 250 to the supplier entities 220, while optionally withholding an agreed upon discount as payment for its services. Then, when the terms) of the payment transaction(s) expire, the buyer entity 210 may make a payment 260 to the selected funding entity(ies) 240, after which all obligations in the SCF solution 200 will have been met.

The foregoing exemplary SCF solution 200 may be better understood by considering the following example. For purposes of this example, it will assumed that the buyer entity 210 owes $100 to the Tier 1 supplier 220a, payable in 100 days; the Tier 1 supplier 220a owes $50 to the Tier 2 supplier 220b, payable in 30 days; and the Tier 2 supplier 220b owes $25 to the Tier 3 supplier 220c, payable in 30 days. This information may be provided to the multilateral netting platform 230 for processing to determine a multilateral netting solution. As a result of said processing, the multilateral netting platform 230 may determine the following solution:
a. each of the Tier 1, 2 and 3 suppliers 220a-c may discount their respective debt by a prevailing annual interest rate if they receive their money today;
b. the multilateral netting platform 230 may determine that a netting operation may offset a portion of the Tier 1 supplier's 220a obligation to the Tier 2 supplier 220b, reducing the obligation from $50 to $25;
c. the multilateral netting platform 230 may also determine the value and quantity of payment transactions needed to satisfy the netted and discounted debt obligations, and in turn submit payment requests to the funding entities 240 who may respond with competitive funding proposals;
d. the buyer entity 210 may accept and select at least one of the funding proposals from at least one funding entity 240, which in this case carries a repayment period of 90 days;
e. the selected funding entity 240 may then issue payment transactions to the supplier entities 220, which in turn allows the multilateral netting platform 230 to perform the netting operation between the Tier 1 supplier 220a and the Tier 2 supplier 220b; and
f. then, when the funded payment transactions reach maturity (i.e., 90 days) the buyer entity may repay the selected funding entity 240.

As will be evident from the foregoing example, the exemplary SCF solution provides many benefits to all members of the supply chain. For example, the supplier entities 220 were able to collect their money today, rather than in the future; the buyer entity 210 was able to extend its repayment terms or obtain a fee form the funding entity; and the funding entity that funded the payment transactions was able to earn a return on its funding activities.

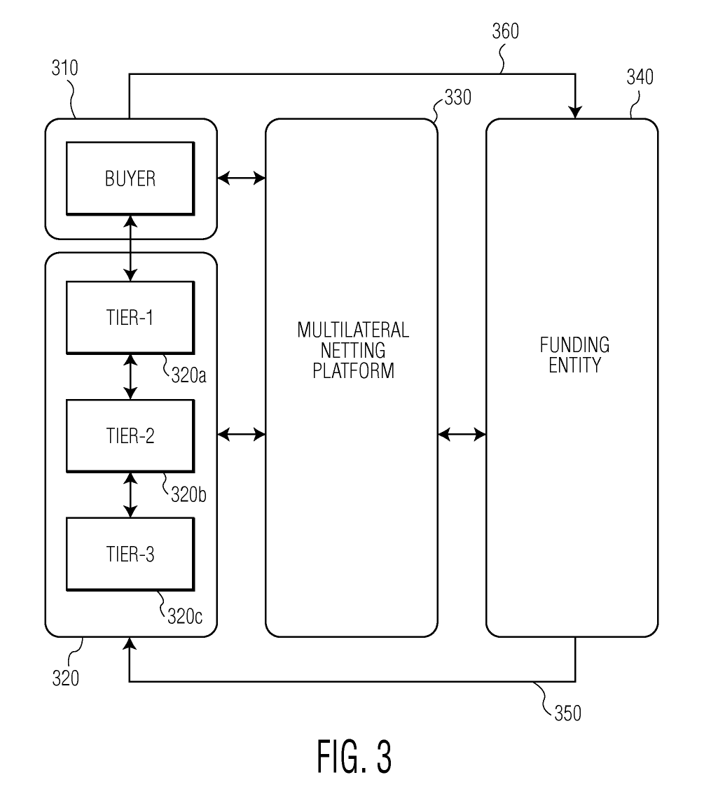

Turning now to FIG. 3, another exemplary SCF solution 300 according to the present disclosure is shown. This exemplary SCF solution 300 includes a buyer entity 210, multi-tiered supplier entities 220 and a multilateral netting platform 230. However, contrary to the exemplary solution 200 of FIG. 2, this SCF solution 300 includes a single dedicated funding entity 340. As such, this solution 300 may be preferred and implemented by banks or other funding entities. Notably, all entities 310, 320, 330 and 340 in this solution may each comprise one or more computing devices connected to each other via wired and/or wireless networks. As such, communications between the entities (included those summarized below) may involve electronic communications between computing devices.

Notably, the solution features and steps in this exemplary SCF solution 300 are very similar to the features and steps of the SCF solution 200 discussed above in connection with FIG. 2, with one major difference. The funding entity 340 in the current SCF solution 300 comprises a single dedicated entity, and as such, does not provide competitive funding alternatives.

As an initial step, the buyer entity 310 and/or the multilateral netting platform 330 may invite one or more of the supplier entities 320 to join the SCF solution 300 and to agree to provide their respective pertinent financial position data and information to the multilateral netting platform 330. This may be accomplished, for example, by inviting the Tier 1 supplier entity 320a first, and the Tier 1 supplier 320a may in turn invite the remaining suppliers 320b-c to join; or all supplier entities 320 may be invited directly. Once the supplier entities 320 have agreed and joined, this will create a single SCF network 300 suitable for implementing a multilateral netting operation across the entire supply chain.

In operation, the supplier entities 320 may supply products to the buyer entity 310. As the products pass through the supply chain, each tiered supplier entity 320 adds value to the products, which results in the generation and submission of invoices along the supply chain.

Once the invoices are approved by the various entities, each entity 310, 320 may submit its accounts payable and/or receivable data and information (from the invoices) to the multilateral netting platform 330 for processing. The multilateral netting platform 330 may then normalize the data and information, define and execute one or more incomplete multilateral netting cycles, and generate one or more payment transaction proposals that may be provided to the buyer entity 310 and/or the supplier entities 320 for negotiation, adjustment and/or approval.

Once the payment transaction proposal(s) are approved, payment transaction request(s) may be submitted to the funding entity 340 for approval. The funding entity 340 may then issue the payment transaction(s) 350 to the supplier entities 320, while optionally withholding an agreed upon discount as payment for its services. Then, when the term(s) of the payment transaction(s) expire, the buyer entity 310 may make a payment 360 to the funding entity 340, after which all obligations in the SCF solution 300 will have been met.

The multilateral netting operation 100 described above (and throughout this disclosure), or portions thereof, may also be implemented to provide obligation recovery functions and services. As will be further described below, the recovery services provided herein enable users to look for specific netting solutions to unpaid debt obligations. In other words, operators of a multilateral netting system may search for and find specific debt obligations between entities, and generate netting cycles specifically configured to resolve (at least partially) these selected debt obligations. These recovery services may be available on demand (in response to a request from a netting participant). An optional fee may be assessed for such recovery services.

The multilateral netting operation 100 described above (and throughout this disclosure), or portions thereof, may also be implemented in connection financial positions that involve or are somehow associated with governmental entities. In such an implementation, at least one of plurality of netting participants may include a government entity and the financial positions (to be multilaterally netted) may include one or more of the following: income tax liability, value added tax (VAT) liability, sales tax liability, government fine, government loan, government debt, government bond, government grant, foreign aid, revenue from state-owned enterprises, rent, concessions and royalties collected by a government from a private enterprise, asset forfeiture, fees generated from granting or issuing permits or licenses, fees generated from public services or facilities, donations, or any other financial positions involving an obligation to or from any government entity.

In yet another implementation, the multilateral netting operations 100 described above (and throughout this disclosure), or portions thereof, may be achieved by a novel independent multilateral netting hub engine, which may be embodied in one or more computer devices. This multilateral netting hub engine may be configured to perform all of the multilateral netting functions and features described herein. However, in certain embodiments, the multilateral netting hub engine may specifically be configured not to perform payment services typically conducted by a Money Transmitter Operator. In such embodiments, the multilateral netting hub engine may perform the multilateral netting operations and generate multilateral payment proposals for other (separate and non-affiliated) payment platforms to process and issue. However, the multilateral netting hub engine will not itself process or issue any payment transactions. Optionally, the multilateral netting hub engine may be connected directly to third party systems (e.g., participant Enterprise Resource Planning (ERP) systems, accounting systems, e-invoicing systems, B2B payment platforms, etc.), and as such, may receive financial position data and information (e.g., accounts receivable and accounts payable information) through such connections.

### Multilateral Netting Methods and Systems

Additional features and aspects of the present disclosure may be understood by examining the following additional exemplary embodiments. In one such exemplary embodiment, a multilateral netting method according to the present disclosure may comprise a computerized multilateral netting method that is executed, at least in part, by a computerized system comprising at least one computing device having one or more processors and memory storing computer-readable instructions. For purposes of this disclosure, a computing device may include (without limitation): a computer terminal, a server, a mobile communication device, a desktop computer, a smart phone, a PDA (personal data assistant), a mobile computer, a tablet computer, or any other such device configured to perform the functions described herein.

The computer-readable instructions, when executed, may cause the computing device to perform and execute multilateral netting operations that include (without limitation) receiving data defining two or more financial positions from a plurality of netting participants; normalizing the data to define two or more comparable financial positions; analyzing the comparable financial positions to define one or more netting cycles; and netting a portion of the comparable financial positions by executing at least one of the defined netting cycles.

Notably, the data that defines the two or more financial positions may be received periodically, at one or more scheduled times, automatically (e.g., as the data becomes available), on an ad-hoc basis and/or at any other time(s) and frequency from one or more computing devices that are in communication with the computerized system over a wired and/or wireless network. Alternatively, the data may be provided to the computerized system via one or more input devices connected directly or indirectly to the computerized system.

The financial positions (defined by the data received into the computerized system) may include one or more debt positions, one or more credit positions and/or a combination of debt and credit positions. Examples of such financial positions include (without limitation) accounts-receivable (AIR); accounts-payable (A/P); loans; commercial debt; secured debt; unsecured debt; private debt; public debt; syndicated debt; bilateral debt; financial derivatives; and any other type of financial position.

Once the data defining financial positions has been received into the system, the exemplary multilateral netting method may include normalizing the data to define two or more comparable financial positions. As will be understood, normalizing generally refers to the process of converting non-standard items into standardized, comparable items. In the context of this disclosure, normalizing financial positions may include converting financial positions having different (and/or incomparable) features, terms, maturities, etc. into financial positions that are comparable for purposes of multilaterally netting. This may be accomplished, for example, by calculating a netting value for each of the financial positions based on one or more parameters of said financial positions. These parameters may include (without limitation) a type of currency, a maturity date, a notional, a creditor, a debtor, and/or any other parameter that defines, is included in or is used to identify a financial position. Once a netting value is calculated for each financial position, the financial positions may be normalized (e.g., comparable) and thus suitable for multilaterally netting.

The netting value calculated by this normalizing operation may be determined by first calculating a discounted value associated with each of the financial positions. This discounted value may be determined, for example, by calculating: a net present value, a value based on an average deposit rate representing interest paid by financial institutions on cash deposits, early payment discounts and/or any other value that may serve as a discounted value. In the case where the discounted value (for the financial positions) is based on a calculated net present value, the net present value may be calculated based on an interest rate, a term and a notional associated with each of the financial positions, respectively. This interest rate may comprise one or more of a government bond interest rate, a non-government bond interest rate, an interest rate representing interest paid by a financial institution on cash deposits and/or any other suitable interest rate. Additionally or alternatively, the net present value may be calculated, at least in part, on discretionary input by a user. That is to say, calculation of the net present value may consider and utilize user input to determine a final value for the net present value.

Additionally or alternatively, if the data defining the financial positions includes notional data, such notional data may be utilized in calculating the discounted values.

Once a discounted value is calculated for each of the financial positions, the discounted values may be utilized to determine a tentative netting value for each financial position. As its name implies, a tentative netting value may be considered a preliminary netting value (i.e., a value attributed to a financial position for comparison and/or multilateral netting purposes) that may be considered, adjusted and/or accepted. As such, a tentative netting value according to the present disclosure may be determined by adjusting the calculated discounted values according to any number of factors. These factors may include (without limitation) a debtor performance factor, a risk factor, a credit rating, a prior netting value, a size of netting participant, a value of a netting participant, a discretionary adjustment provided as an input by a user, a liquidity of a netting participant and/or any other adjustment factor. Notably, this adjustment may occur automatically and/or upon approval or confirmation by a user or netting participant.

Optionally, once a tentative netting value is determined for a particular financial position, the exemplary multilateral netting method may further include initiating a negotiation (between two or more netting participants) to determine a final netting value based on the tentative netting value for that particular financial position. Initiating such a negotiation may include transmitting the tentative netting value to netting participants (e.g., owner and counterparty of the financial position), receiving one or more proposed adjustments to the tentative netting value, and receiving a validation from the netting participants confirming that the tentative netting value, as adjusted according to the negotiation, is acceptable to said netting participants.

Alternatively, rather than utilizing the discounted value to determine a tentative netting value (that may be adjusted based on, for example, negotiations), the calculated discounted value may be utilized without adjustment as the finalized netting value.

As another option, in the case where at least one of the financial positions is a debt position defined by two or more debt payments, the exemplary multilateral netting method may include disaggregating (i.e., dividing) the debt position into its individual debt payments such that each debt payment may itself be treated as an individual financial position. After this disaggregating step, the method may include calculating a discounted value for at least one of the debt payments and automatically calculating a tentative netting value (for said debt payment) based on the calculated discounted value. Notably, the calculated tentative netting value may be greater than, equal to or less than the calculated discounted value. Once the netting value is calculated, the method may include initiating a negotiation between an owner of the debt position and at least one other netting participant. Then, based on the negotiation, the tentative netting value for the debt payment(s) may be adjusted.

Once the financial positions are normalized, the exemplary multilateral netting method may include analyzing the (now) comparable financial positions to define one or more netting cycles. This analyzing operation may include identifying interdependencies between financial positions so as to facilitate defining netting cycle(s) that achieve desired netting goals. For example, the one or more netting cycles may be defined to achieve: a maximized, minimized, optimal or predetermined number of debt positions that are at least partially cancelled (as a result of executing the netting cycle(s)); a maximized, minimized, optimal or predetermined value of cancelled debt positions; a maximized, minimized, optimal or predetermined number of netting participants included in the one or more netting cycles; a maximized, minimized, optimal or predetermined netted notional of netted financial positions; a maximized, minimized, optimal or predetermined amount of fees generated by executing the one or more netting cycles, and/or any other desired goals that may be achievable as a result of executing the netting cycle(s).

The netting cycles defined in accordance with this exemplary method may include one or more complete netting cycles and/or incomplete netting cycles. As noted above, a complete netting cycle may be defined as including a plurality of comparable financial positions owned by a first group of netting participants that each holds at least one debt position against one other netting participant in said first group. In contrast, an incomplete netting cycle may be defined as including a plurality of comparable financial positions owned by a second group of netting participants, at least one of which does not hold a debt position against any other netting participant in said second group.

In conjunction with defining one or more netting cycles, the exemplary method may determine that at least one payment transaction is needed to satisfy any unnetted portions of the comparable financial positions included in the one or more netting cycles. In such an instance, the exemplary method may further include generating one or more payment proposals and transmitting the payment proposals to one or more netting participants (e.g., via netting participant computing devices). If the payment proposal(s) are approved, the method may include receiving (at the computerized multilateral netting system) approval to issue the payment transaction(s) from one or more of the netting participants, receiving funds from an external funding entity and/or one or more of the netting participants (to fund the payment transaction), cancelling at least a portion of debt positions included in the defined netting cycle(s) and issuing the payment transaction(s). A portion of the received funds may be retained as a surcharge for issuing the payment transaction(s).

Optionally, prior to receiving approval, the exemplary method may include adjusting a value of at least one of the payment proposals and receiving funds according to the adjustment. This adjustment may be made by the computerized system automatically and/or in response to input from a user or a netting participant.

In one embodiment, a payment transaction may comprise one or more multilateral payments that when issued, satisfies at least two different debt obligations included in the financial positions included in the netting cycles. In other words, the method may include determining a payment transaction that itself is able to satisfy multiple debt obligations between a group of netting participants involved in a multilateral netting operation. This may occur, for example, in a scenario in which participant A owes an amount to participant B and participant B owes an amount to participant C. As a result of netting the obligations, A's obligation to B is completely offset and a portion of B's obligation to C remains outstanding. A single multilateral payment from A to C will satisfy the unnetted portion of B's obligation to C, while at the same time satisfying both A's obligation to B and B's obligation to C.

As an option, the function of issuing the payment transaction(s) may be carried out via a money transmitter operator engine (embodied in at least one computing device) that is authorized to carry out payment services in a predetermined area. This money transmitter operator engine may be a part of the computerized system that is executing this exemplary multilateral netting method. Or alternatively, the money transmitter operator engine may be embodied in at least one computing device that pertains to a payment processing enterprise unaffiliated with the computerized system that executes the receiving, normalizing, analyzing and netting functions of this exemplary multilateral netting method. Such a payment processing enterprise may include (without limitation) a bank, an electronic payment platform, an enterprise resource planning (ERP) platform, an electronic accounting system, an electronic invoicing system and/or any other suitable payment processing enterprise.

As another option, in instances where at least one of the financial positions includes a debt position (e.g., a debt obligation), the computerized multilateral netting method may support adjustments to the debt positions. Such adjustments may occur prior to and/or after the netting cycles have been defined. Adjustments to debt positions may possibly affect the overall netting outcome of the netting cycles, as well as size of any eventual payment transactions) needed to satisfy any unnetted obligations resulting from executing the netting cycles. In order to support such adjustments, the computerized multilateral netting method may include generating one or more debt adjustment proposals, transmitting debt adjustment proposals to one or more of the netting participants that are involved in the multilateral netting method and receiving approval from one or more of the netting participants to adjust the debt obligation according to the debt adjustment proposal(s).

As an option, at any point prior to completing the netting function, one or more of the financial positions may be withdrawn, and the remaining financial positions may be re-analyzed to define new netting cycle(s) and netted according to the new netting cycle(s).

Once the netting cycles have been defined and executed, the exemplary computerized multilateral netting method may optionally include issuing one or more notifications to one or more of the netting participants (e.g., via netting participant computing devices) providing results of the one or more netting cycles. Additionally or alternatively, the notifications may optionally include a confirmation that said netting cycles have been executed and completed. The confirmation issued to each netting participant may optionally only include information pertaining to those financial positions to which each netting participant is a party, or the confirmation may include information pertaining to all financial positions included in the netting cycles. Such confirmations may be transmitted directly into a netting participant's computerized receiving and account system, or it may be transmitted over a wired or wireless network such that it may be accessible by a netting participant computing device.

In an alternate embodiment, a computerized multilateral netting method according to the present disclosure may be configured to track financial positions through their respective life cycles, and generate, store and submit life cycle documentation to netting participant computing systems. In such an embodiment, the computerized multilateral netting method may include the steps of tracking, by at least one computing device, one or more financial positions throughout their respective life cycles and automatically generating legal documentation related to the life cycles. This life cycle documentation may be stored for future use and/or it may be automatically submitted to one or more participant computing systems. Such future use may include, for example, use for audits (both internal and external), use legal purposes, compliance reporting and/or any other desired purposes.

An exemplary multilateral netting system according to the present disclosure may comprise, for example, one or more computer devices, each comprising a processor configured to execute computer-readable instructions. The exemplary system may comprise one single, co-located system, or it may comprise multiple independent sub-systems, at various locations, coupled and configured to operate together. For systems including multiple computing devices, the computing devices may be configured to communicate with each other via a wired and/or wireless network. For purposes of this disclosure, a computer device may include (without limitation) a computer terminal, a server, a mobile communication device, a desktop computer, a smart phone, a PDA (personal data assistant), a mobile computer, a tablet computer, or any other such device configured to perform the functions described herein.

In one embodiment, the exemplary multilateral netting system (and/or its components, whether individually or collectively) may include computer-readable instructions that, when executed, causes the multilateral netting system to perform any or all of the multilateral netting methods, processes, functions and/or operations described herein. These multilateral netting operations may include (without limitation) receiving data defining financial positions, normalizing the received financial position data to define comparable financial positions, analyzing the comparable positions to define one or more netting cycles, executing the netting cycles to net a least a portion of the financial positions and all sub-operations and functions associated therewith.

In addition, the exemplary multilateral netting system may be configured to perform all calculations described herein (e.g., discounted values, tentative netting values, netting values, net present values, etc.); initiate and facilitate negotiations between netting participants; disaggregate debt positions defined by multiple debt payments; generate and issue (or transmit) invitations, notifications, confirmations, payment proposals, debt adjustment proposals, netting proposals, funding proposals, etc.; adjust values (e.g., tentative netting values, debt obligation values, net present values, discounted values, etc.); issue multilateral payment transactions (or portions thereof); track, store and report financial position life cycle data and information; communicate (e.g., via wired or wireless networks) with external netting participant systems, funding enterprises and payment platforms (e.g., banking platform, electronic payment platform, enterprise resource planning (ERP) platform, electronic accounting system, money transmitter system, payment institution system, electronic invoicing system, etc.); and all other functions and features described herein.

### Supply Chain Finance (SCF)

Turning now to possible implementations, the computerized multilateral netting methods and systems described above may be implemented in connection with a supply chain finance (SCF) process/system. In such an implementation, the plurality of netting participants involved in the multilateral netting process may include a plurality of corporate enterprises that form a value chain, and their financial positions may include at least one corporate debt obligation between at least two of the corporate enterprises.

This multilateral netting process may commence, for example, by generating and transmitting an invitation to the plurality of corporate enterprises to participate in the multilateral netting process. Those that accept may provide data and information defining their respective financial positions to a computerized multilateral netting system according to the present disclosure. The multilateral netting system may in turn normalize the received data to define comparable financial positions, analyze the comparable financial positions to define one or more netting cycles, and execute the netting cycles.

In one embodiment, the corporate enterprises forming the value chain may include at least one corporate buying entity and at least two corporate supplier entities that each represents a different tier of a multi-tiered supply chain. For example, one supplier entity may be a tier 1 supplier and a second supplier entity may be a tier 2 supplier, and so on. Collectively, these corporate enterprises form a multi-tiered value chain.

The netting cycles defined in this exemplary embodiment may include an Incomplete Multilateral Netting Cycle requiring at least one payment transaction to satisfy any unnetted portions of the financial positions included in the Incomplete Multilateral Netting Cycle. Such a payment transaction may be funded with funds received from one or more of the corporate enterprises participating in the multilateral netting process, funds received from at least one external funding entity, and/or a combination of thereof.

In one embodiment, the external funding entity may include one or more dedicated external funding entities, in which case funding a payment transaction may involve receiving one or more non-competitive funding proposals (e.g., at the multilateral netting system) from the dedicated external funding entities; accepting (e.g., by at least one participating corporate enterprise) at least one of the non-competitive funding proposals; and funding at least a portion of the payment transaction by issuing a payment to at least one corporate enterprise in the value chain with the accepted funding proposals.

Alternatively, the external funding entity may include two or more competitive funding entities, in which case funding a payment transaction may involve receiving one or more competitive funding proposals (e.g., at the multilateral netting system) for funding at least a portion of the payment transaction from each of the two or more external funding entities; accepting (e.g., by at least one participating corporate enterprise) at least one of the competitive funding proposals; and funding at least a portion of the payment transaction by issuing a payment to at least one corporate enterprise in the value chain with the accepted funding proposals.

In either case, the payment transaction (or at least a portion thereof) may be discounted by issuing said payment transaction prior to its previously-established payment maturity date. Similarly, in cases where two or more payments transactions are issued to different corporate enterprises representing at least two different tiers of a multi-tiered value chain, the two or more payment transactions may be discounted by issuing said two or more payment transactions prior to their respective previously-established payment maturity dates. For example, if a payment transaction will be used to satisfy a debt obligation that is due in 90 days, and said payment transaction is issued ahead of the due date (e.g., in 30 days), the amount of the payment transaction may reflect a discounted value of the debt obligation to account for the early payment.

Once the payment transaction(s) is issued, funds received from any external funding entity to satisfy one or more debt obligations may be reimbursed to said external funding entity either at or after a previously-established payment maturity date of said one or more debt obligations.

Notably, all payment transactions for portions thereof) issued in accordance with this disclosure may be issued directly by the multilateral netting system and/or by an external payment processing enterprise that is unaffiliated with said multilateral netting system.

### Netting Hub

In yet another exemplary implementation, a multilateral netting system according to the present disclosure may include a netting hub engine embodied in at least one computing device. This netting hub engine may including instructions that, when executed, cause the computing device to perform any or all of the multilateral netting operations described above. Such operations may include (without limitation) receiving data defining financial positions. Such data may include (without limitation) accounts-receivable (AIR) data; accounts-payable (A/P) data; loan data; commercial debt data; secured debt data; unsecured debt data; private debt data; public debt data; syndicated debt data; bilateral debt data; and financial derivative data.

The netting hub engine may also be configured to perform additional multilateral netting operations such as normalizing the received financial position data to define comparable financial positions, analyzing the comparable positions to define one or more netting cycles, executing the netting cycles to net a least a portion of the financial positions and all sub-operations and functions associated therewith.

In addition, the netting hub engine may be configured to perform all calculations described herein (e.g., discounted values, tentative netting values, netting values, net present values, etc.); initiate and facilitate negotiations between netting participants; disaggregate debt positions defined by multiple debt payments; generate and issue (or transmit) invitations, notifications, confirmations, payment proposals, debt adjustment proposals, netting proposals, funding proposals, etc.; adjust values (e.g., tentative netting values, debt obligation values, net present values, discounted values, etc.); issue multilateral payment transactions (or portions thereof); track, store and report financial position life cycle data and information; communicate (e.g., via wired or wireless networks) with external netting participant systems, funding enterprises and payment platforms (e.g., banking platform, electronic payment platform, enterprise resource planning (ERP) platform, electronic accounting system, money transmitter system, payment institution system, electronic invoicing system, etc.); and all other functions and features described herein.

### Recovery

In another exemplary implementation, the multilateral netting methods and systems described herein may be configured for identifying and netting certain specified financial positions (e.g., certain identified debt positions) out of a group of financial positions. In such an implementation, a selection identifying a collection (e.g., a sub-set) of financial positions that includes at least one particular debt position to be cancelled (or offset) may be received (e.g., at a multilateral netting system according to the present disclosure) from a netting participant (e.g., via a netting participant computing device). Upon receiving this selection, the multilateral netting system may perform multilateral netting operations such as normalizing the collection of financial positions, analyzing the collection of financial positions to define one or more netting cycles that results in a cancellation (or offsetting) of the particular debt position, and then netting the collection of financial positions by executing the one or more defined netting cycles to cancel or offset the particular debt position.

Optionally, a recovery fee for defining and executing the one or more defined netting cycles that results in a cancellation of the particular debt position may be assessed and collected by the multilateral netting system. As another option, the selection of financial positions may be received and processed by the multilateral netting system on-demand (i.e., at any time desired by a netting participant).

### Fiscal Netting

In still another exemplary implementation, the multilateral netting methods and systems described herein may be configured for multilaterally netting financial positions that involve or are somehow associated with governmental entities. In such an implementation, at least one of plurality of netting participants is a government entity and the financial positions (to be multilaterally netted) may include one or more of the following: income tax liability, value added tax (VAT) liability, sales tax liability, government fine, government loan, government debt, government bond, government grant, foreign aid, revenue from state-owned enterprises, rent, concessions and royalties collected by a government from a private enterprise, asset forfeiture, fees generated from granting or issuing permits or licenses, fees generated from public services or facilities, donations, or any other financial positions involving an obligation to or from any government entity.

While certain embodiments have been described above, it will be understood that the embodiments described are by way of example only. Accordingly, the present disclosure should not be limited based on the described embodiments. Rather, the scope of the present disclosure should only be limited in light of the claims that follow when taken in conjunction with the above description and accompanying drawings.

1. A computerized multilateral netting method comprising:
in a computerized system comprising at least one computing device configured to execute computer-readable instructions:
receiving, at the at least one computing device, data defining two or more financial positions from a plurality of netting participants;
normalizing, by the at least one computing device, said data to define two or more comparable financial positions;
analyzing, by the at least one computing device, said comparable financial positions to define one or more netting cycles; and
netting, by the at least one computing device, a portion of the comparable financial positions, said netting comprising executing said one or more netting cycles.

2. The method of claim 1, wherein said data is received according to at least one of the following:
periodically, at one or more scheduled times, automatically as said data becomes available, and on an ad-hoc basis from at least one of:
one or more computing devices in communication with said computerized system over a wired or wireless network, and
one or more input devices connected directly or indirectly to said computerized system.

3. The method of claim 1, wherein the financial positions include at least one of a debt position and a credit position.

4. The method of claim 3, wherein the one or more netting cycles are defined to achieve at least one of:
a maximized, minimized, optimal or predetermined number of debt positions that are totally cancelled;
a maximized, minimized, optimal or predetermined number of debt positions that are at least partially cancelled;
a maximized, minimized, optimal or predetermined value of cancelled debt positions;
a maximized, minimized, optimal or predetermined number of netting participants included in the one or more netting cycles;
a maximized, minimized, optimal or predetermined netted notional of netted financial positions; and
a maximized, minimized, optimal or predetermined fees generated by executing the one or more netting cycles.

5. The method of claim 1, wherein said normalizing step comprises calculating a netting value for each of the two or more financial positions based on one or more parameters of said two or more financial positions.

6. The method of claim 5, wherein the netting value for at least one of the financial positions is defined as a tentative netting value, the method further comprising:
initiating a negotiation between owners of the two or more financial positions, said negotiation comprising:
transmitting said netting values, including said tentative netting value, to said owners,
receiving one or more proposed adjustments to said tentative netting value, and
receiving a validation from said owners confirming that the tentative netting value, as adjusted according to the negotiation, is acceptable to said owners.

7. The method of claim 6, wherein said tentative netting value is determined by calculating a discounted value and automatically adjusting the discounted value based on at least one of a debtor performance factor, a risk factor, a credit rating, a prior netting value, a size of netting participant, a value of a netting participant, a discretionary adjustment provided as an input by a user and a liquidity of a netting participant,
said method further comprising initiating the negotiation to finalize said netting value.

8. The method of claim 1, wherein the data defining two or more financial positions includes notional data, and wherein the normalizing step comprises:
calculating a discounted value for each of the two or more financial positions based on the notional data;
automatically calculating a tentative netting value for said two or more financial positions by adjusting the calculated discounted values;
initiating a negotiation between owners of the two or more financial positions; and
adjusting the tentative netting value for at least one of said two or more financial positions based on said negotiation.

9. The method of claim 8, wherein the calculated discounted value for at least one of the two or more financial positions is used without adjusting as the tentative netting value.

10. The method of claim 8, wherein at least one of the financial positions is a debt position defined by two or more debt payments, the method further comprising:
disaggregating the debt position into its individual debt payments;
calculating a discounted value for at least one of the debt payments;
automatically calculating a tentative netting value for said at least one debt payment based on the calculated discounted value, wherein said tentative netting value is greater than, equal to or less than the calculated discounted value;
initiating a negotiation between an owner of the debt position and at least one other netting participant; and
adjusting the tentative netting value for at least one of said debt payments based on said negotiation.

11. The method of claim 8, wherein calculating the discounted value comprises calculating at least one of:
a net present value,
a value based on an average deposit rate representing interest paid by financial institutions on cash deposits, and
early payment discounts.

12. The method of claim 11, wherein the net present value is calculated based on an interest rate, a term and a notional associated with at least one of the two or more financial positions, said interest rate comprising one or more of a government bond interest rate, non-government bond interest rate and an interest rate representing interest paid by a financial institution on cash deposits.

13. The method of claim 11, wherein the net present value is calculated, at least in part, based on discretionary input provided by a user.

14. The method of claim 1, wherein the analyzing step includes identifying interdependencies between financial positions.

15. The method of claim 1, further comprising:
issuing, by the at least one computing device, one or more notifications to one or more of the netting participants, said notifications providing results of the one or more netting cycles.

16. The method of claim 1, wherein the one or more netting cycles comprises at least one of a complete netting cycle and an incomplete netting cycle,
wherein the complete netting cycle includes a plurality of comparable financial positions owned by a first group of netting participants that each holds at least one debt position against one other netting participant in said first group, and
wherein the incomplete netting cycle includes a plurality of comparable financial positions owned by a second group of netting participants at least one of which does not hold a debt position against any other netting participant in said second group.

17. The method of claim 16, wherein at least one payment transaction is needed to satisfy any unnetted portions of the comparable financial positions included in said one or more netting cycles, the method further comprising:
generating one or more payment proposals and transmitting said payment proposals to one or more of the plurality of netting participants;
receiving approval from one or more of the plurality netting participants to issue the at least one payment transaction;
receiving funds from at least one of an external funding entity and one or more of the plurality of netting participants;
cancelling at least a portion of debt positions included in the one or more netting cycles; and
issuing the at least one payment transaction to one or more of the plurality of netting participants to satisfy any unnetted portions of the financial positions included in said one or more netting cycles.

18. The method of claim 17, wherein the at least one payment transaction comprises at least one multilateral payment that when issued, satisfies at least two different debt obligations included in the financial positions included in said one or more netting cycles.

19. The method of claim 17, further comprising:
adjusting a value of at least one of the one or more payment proposals before receiving said approval; and
receiving funds according to said adjustment.

20. The method of claim 17, wherein the issuing step is carried out by a money transmitter operator engine that is authorized to carry out payment services in a predetermined area, said money transmitter operator engine being embodied in at least one computing device.

21. The method of claim 20, wherein the at least one computing device that embodies the money transmitter operator engine is a part of the computerized system that executes the receiving, normalizing, analyzing and netting functions.

22. The method of claim 20, wherein said money transmitter operator engine is embodied in at least one computing device that pertains to a payment processing enterprise unaffiliated with the computerized system that executes the receiving, normalizing, analyzing and netting functions.

23. The method of claim 22, wherein said payment processing enterprise includes at least one of a bank, electronic payment platform, enterprise resource planning (ERP) platform, electronic accounting system, and electronic invoicing system.

24. The method of claim 1, wherein the two or more financial positions includes at least one debt obligation, the method further comprising:
generating one or more debt adjustment proposals in accordance with the one or more netting cycles and transmitting said debt adjustment proposals to one or more of the plurality of netting participants; and
receiving approval from one or more of the plurality netting participants to adjust the at least one debt obligation according to the one or more debt adjustment proposals.

25. The method of claim 1, further comprising issuing a confirmation to one or more of the plurality of netting participants upon completion of the netting step to confirm that said netting step has been completed.

26. The method of claim 25, wherein the confirmation issued to each netting participant only includes information pertaining to those financial positions to which said netting participant is a party.

27. The method of claim 26, wherein the confirmation for at least one netting participant is transmitted directly into said at least one netting participant's computerized receiving and account system.

28. The method of claim 1, further comprising:
tracking, by the at least one computing device, at least one of the two or more financial positions throughout their respective life cycles;
automatically generating, by the at least one computing device, legal documentation related to said life cycles;
storing, by the at least one computing device, of said legal documentation for future use; and
automatically submitting, by the at least one computing device, documentation related to said life cycles to one or more netting participant computing systems.

29. The method of claim 1, further comprising:
withdrawing at least one of the two or more financial positions prior to completing of the netting step; and
performing at least said analyzing and netting steps upon said withdrawal.

30. The method of claim 1, wherein the two or more financial positions comprise one or more of the following position types:
accounts-receivable (A/R);
accounts-payable (A/P);
loans;
commercial debt;
secured debt;
unsecured debt;
private debt;
public debt;
syndicated debt;
bilateral debt; and
financial derivative.

31. The method of claim 5, wherein the one or more parameters include at least one of:
a type of currency;
a maturity date;
a notional;
a creditor; and
a debtor.

32. The method of claim 16, wherein the plurality of netting participants comprises a plurality of corporate enterprises that form a value chain, wherein the two or more financial positions comprise at least one corporate debt obligation between at least two of the plurality of corporate enterprises.

33. The method of claim 32, wherein the one or more netting cycles comprises an incomplete netting cycle requiring at least one payment transaction to satisfy any unnetted portions of the financial positions included in said incomplete netting cycle.

34. The method of claim 32, further comprising:
generating and transmitting, by the at least one computing device, an invitation to the plurality of corporate enterprises to participate in a multilateral netting process.

35. The method of claim 33, wherein the value chain includes at least one corporate buying entity and at least two corporate supplier entities, said corporate supplier entities representing different tiers of a multi-tiered supply chain, wherein the plurality of corporate enterprises collectively form a multi-tiered value chain, and
wherein the at least one payment transaction is funded by a combination of funds received from one or more of the corporate enterprises and funds received from at least one external funding entity.

36. The method of claim 35, wherein the at least one external funding entity includes one or more dedicated external funding entities, the method further comprising:
receiving one or more non-competitive funding proposals for funding at least a portion of the at least one payment transaction from said dedicated external funding entities;
accepting at least one of the non-competitive funding proposals; and
funding at least a portion of the at least one payment transaction with the accepted funding proposals.

37. The method of claim 35, wherein the at least one external funding entity includes two or more external funding entities, the method further comprising:
receiving one or more competitive funding proposals for funding at least a portion of the at least one payment transaction from each of the two or more external funding entities;
accepting at least one of the competitive funding proposals; and
funding at least a portion of the at least one payment transaction with the accepted funding proposals.

38. The method of claim 35, wherein the at least one payment transaction is issued to at least one corporate enterprise in the value chain.

39. The method of claim 38, further comprising discounting at least a portion of the at least one payment transaction by issuing said at least one payment transaction prior to a previously-established payment maturity date.

40. The method of claim 38, wherein the at least one payment transaction comprises two or more payments transactions issued to different corporate enterprises representing at least two different tiers of a multi-tiered value chain, the method further comprising:
discounting the two or more payment transactions by issuing said two or more payment transactions prior to their respective previously-established payment maturity dates.

41. The method of claim 38, further comprising reimbursing funds received from the at least one external funding entity at or after a previously-established payment maturity date.

42. The method of claim 1, wherein the at least one computing device includes a netting hub engine, said netting hub engine including instructions that, when executed, cause said at least one computing device to perform said receiving, normalizing, analyzing and netting functions.

43. The method of claim 42, wherein the data defining the two or more financial positions includes at least one of:
accounts-receivable (A/R) data;
accounts-payable (A/P) data.
loan data;
commercial debt data;
secured debt data;
unsecured debt data;
private debt data;
public debt data;
syndicated debt data;
bilateral debt data; and
financial derivative data.

44. The method of claim 42, further comprising:
generating, by said netting hub engine, at least one of one or more payment proposals and one or more netting proposals based on results from the analyzing function; and
transmitting at least one of said payment proposals, netting proposals and one or more funding proposals received from at least one external funding entity to one or more payment platforms associated with at least one of the netting participants for processing,
said payment platforms including one or more of a:
banking platform,
electronic payment platform,
enterprise resource planning (ERP) platform,
electronic accounting system,
money transmitter system,
payment institution system, and
electronic invoicing system.

45. The method of claim 1, further comprising:
receiving a selection from at least one of the netting participants, said selection identifying a collection of financial positions that includes at least one particular debt position identified by said at least one netting participant;
normalizing said collection;
analyzing said collection to define one or more netting cycles that result in a cancellation of the at least one particular debt position identified by the at least one netting participant; and
netting said collection by executing the one or more defined netting cycles.

46. The method of claim 45, further comprising:
collecting a recovery fee for defining and executing the one or more defined netting cycles that result in a cancellation of the at least one debt position.

47. The method of claim 45, wherein the selection is received on-demand.

48. The method of claim 1, wherein at least one of the netting participants includes a government entity, and wherein the two or more financial positions include at least one of a:
income tax liability,
value added tax (VAT) liability,
sales tax liability,
government fine,
government loan,
government debt,
government bond,
government grant,
foreign aid,
revenue from state-owned enterprises,
rent, concessions and royalties collected by a government from a private enterprise,
asset forfeiture,
fees generated from granting or issuing permits or licenses,
fees generated from public services or facilities, and
donations.

49. A multilateral netting system comprising one or more computing devices in communication with one another via at least one of a wired and wireless network, each of said computing devices comprising one or more processors and memory storing computer-readable instructions that when executed cause said one or more computing devices to:
receive data defining two or more financial positions from a plurality of netting participants;
normalize said data to define two or more comparable financial positions;
analyze said comparable financial positions to define one or more netting cycles; and
execute said one or more netting cycles to net a portion of the comparable financial positions.

50. The system of claim 49, wherein said data is received according to at least one of the following:
periodically, at one or more scheduled times, automatically as said data becomes available, and on an ad-hoc basis from at least one of:
one or more other computing devices in communication with said multilateral netting system over a wired or wireless network, and
one or more input devices connected directly or indirectly to said multilateral netting system.

51. The system of claim 49, wherein the financial positions include at least one of a debt position and a credit position.

52. The system of claim 51, wherein the one or more netting cycles are defined to achieve at least one of:
a maximized, minimized, optimal or predetermined number of debt positions that are totally cancelled;
a maximized, minimized, optimal or predetermined number of debt positions that are at least partially cancelled;
a maximized, minimized, optimal or predetermined value of cancelled debt positions;
a maximized, minimized, optimal or predetermined number of netting participants included in the one or more netting cycles;
a maximized, minimized, optimal or predetermined netted notional of netted financial positions; and
a maximized, minimized, optimal or predetermined fees generated by executing the one or more netting cycles.

53. The system of claim 49, wherein said normalizing function is achieved by executing instructions that cause the one or more computing devices to calculate a netting value for each of the two or more financial positions based on one or more parameters of said two or more financial positions.

54. The system of claim 53, wherein the netting value for at least one of the financial positions is defined as a tentative netting value, the system further comprising instructions that when executed cause the one or more computing devices to:
initiate a negotiation between owners of the two or more financial positions, said negotiation comprising:
transmitting said netting values, including said tentative netting value, to said owners,
receiving one or more proposed adjustments to said tentative netting value, and
receiving a validation from said owners confirming that the tentative netting value, as adjusted according to the negotiation, is acceptable to said owners.

55. The system of claim 54, wherein said tentative netting value is determined by calculating a discounted value and automatically adjusting the discounted value based on at least one of a debtor performance factor, a risk factor, a credit rating, a prior netting value, a size of netting participant, a value of a netting participant, a discretionary adjustment provided as an input by a user and a liquidity of a netting participant,
said system further comprising instructions that when executed cause the one or more computing devices to initiate the negotiation to finalize said netting value.

56. The system of claim 49, wherein the data defining two or more financial positions includes notional data, and wherein the normalizing function is achieved by executing instructions that cause the one or more computing devices to:
calculate a discounted value for each of the two or more financial positions based on the notional data;
automatically calculate a tentative netting value for said two or more financial positions by adjusting the calculated discounted values;
initiate a negotiation between owners of the two or more financial positions; and
adjust the tentative netting value for at least one of said two or more financial positions based on said negotiation.

57. The system of claim 56, wherein the calculated discounted value for at least one of the two or more financial positions is used without adjusting as the tentative netting value.

58. The system of claim 56, wherein at least one of the financial positions is a debt position defined by two or more debt payments, the system further comprising instructions that when executed cause the one or more computing devices to:
disaggregate the debt position into its individual debt payments;
calculate a discounted value for at least one of the debt payments;
automatically calculate a tentative netting value for said at least one debt payment based on the calculated discounted value, wherein said tentative netting value is greater than, equal to or less than the calculated discounted value;
initiate a negotiation between an owner of the debt position and at least one other netting participant; and
adjust the tentative netting value for at least one of said debt payments based on said negotiation.

59. The system of claim 56, wherein the discounted value is calculated by executing instructions that cause the one or more computing devices to calculate at least one of:
a net present value,
a value based on an average deposit rate representing interest paid by financial institutions on cash deposits, and
early payment discounts.

60. The system of claim 59, wherein the net present value is calculated based on an interest rate, a term and a notional associated with at least one of the two or more financial positions, said interest rate comprising one or more of a government bond interest rate, non-government bond interest rate and an interest rate representing interest paid by a financial institution on cash deposits.

61. The system of claim 59, wherein the net present value is calculated, at least in part, based on discretionary input provided by a user.

62. The system of claim 49, wherein the analyzing function is achieved by executing instructions that cause the one or more computing devices to identify interdependencies between financial positions.

63. The system of claim 49, further comprising instructions that when executed cause the one or more computing devices to:
issue one or more notifications to one or more of the netting participants, said notifications providing results of the one or more netting cycles.

64. The system of claim 49, wherein the one or more netting cycles comprises at least one of a complete netting cycle and an incomplete netting cycle,
wherein the complete netting cycle includes a plurality of comparable financial positions owned by a first group of netting participants that each holds at least one debt position against one other netting participant in said first group, and
wherein the incomplete netting cycle includes a plurality of comparable financial positions owned by a second group of netting participants at least one of which does not hold a debt position against any other netting participant in said second group.

65. The system of claim 64, wherein at least one payment transaction is needed to satisfy any unnetted portions of the comparable financial positions included in said one or more netting cycles, the system further comprising instructions that when executed cause the one or more computing devices to:
generate one or more payment proposals and transmitting said payment proposals to one or more of the plurality of netting participants;
receive approval from one or more of the plurality netting participants to issue the at least one payment transaction;
receive funds from at least one of an external funding entity and one or more of the plurality of netting participants;
cancel at least a portion of debt positions included in the one or more netting cycles; and
issue the at least one payment transaction to one or more of the plurality of netting participants to satisfy any unnetted portions of the financial positions included in said one or more netting cycles.

66. The system of claim 65, wherein the at least one payment transaction comprises at least one multilateral payment that when issued, satisfies at least two different debt obligations included in the financial positions included in said one or more netting cycles.

67. The system of claim 65, further comprising instructions that when executed cause the one or more computing devices to:
adjust a value of at least one of the one or more payment proposals before receiving said approval; and
receive funds according to said adjustment.

68. The system of claim 65, further comprising at least one money transmitter operator engine being embodied in at least one computing device and in communication with said multilateral netting system, said at least one money transmitter operator engine being configured to issue the at least one payment transaction.

69. The system of claim 68, wherein the at least one money transmitter operator engine is embodied in the one or more computing devices configured to execute the receiving, normalizing, analyzing and netting functions.

70. The system of claim 68, wherein the at least one money transmitter operator engine is embodied in at least one computing device that pertains to a payment processing enterprise unaffiliated with the multilateral netting system that executes the receiving, normalizing, analyzing and netting functions, but in communication with said multilateral netting system.

71. The system of claim 70, wherein said payment processing enterprise includes at least one of a bank, electronic payment platform, enterprise resource planning (ERP) platform, electronic accounting system, and electronic invoicing system.

72. The system of claim 49, wherein the two or more financial positions includes at least one debt obligation, the system further comprising instructions that when executed cause the one or more computing devices to:
generate one or more debt adjustment proposals in accordance with the one or more netting cycles and transmit said debt adjustment proposals to one or more of the plurality of netting participants; and
receive approval from one or more of the plurality netting participants to adjust the at least one debt obligation according to the one or more debt adjustment proposals.

73. The system of claim 49, further comprising instructions that when executed cause the one or more computing devices to issue a confirmation to one or more of the plurality of netting participants upon completion of the netting function to confirm that said netting function has been completed.

74. The system of claim 73, wherein the confirmation issued to each netting participant only includes information pertaining to those financial positions to which said netting participant is a party.

75. The system of claim 74, wherein the confirmation for at least one netting participant is transmitted directly into said at least one netting participant's computerized receiving and account system.

76. The system of claim 49, further comprising instructions that when executed cause the one or more computing devices to:
track at least one of the two or more financial positions throughout their respective life cycles;
automatically generate legal documentation related to said life cycles;
store said legal documentation for future use; and
automatically submit documentation related to said life cycles to one or more netting participant computing systems.

77. The system of claim 49, further comprising instructions that when executed cause the one or more computing devices to:
withdraw at least one of the two or more financial positions prior to completing of the netting function; and
perform at least said analyzing and netting functions upon said withdrawal.

78. The system of claim 49, wherein the two or more financial positions comprise one or more of the following position types:
accounts-receivable (A/R);
accounts-payable (A/P);
loans;
commercial debt;
secured debt;
unsecured debt;
private debt;
public debt;
syndicated debt;
bilateral debt; and
financial derivative.

79. The system of claim 53, wherein the one or more parameters include at least one of:
a type of currency;
a maturity date;
a notional;
a creditor; and
a debtor.

80. The system of claim 64, wherein the plurality of netting participants comprises a plurality of corporate enterprises that form a value chain, wherein the two or more financial positions comprise at least one corporate debt obligation between at least two of the plurality of corporate enterprises.

81. The system of claim 80, wherein the one or more netting cycles comprises an incomplete netting cycle requiring at least one payment transaction to satisfy any unnetted portions of the financial positions included in said incomplete netting cycle.

82. The system of claim 80, further comprising instructions that when executed cause the one or more computing devices to:
generate and transmit an invitation to the plurality of corporate enterprises to participate in a multilateral netting process.

83. The system of claim 81, wherein the value chain includes at least one corporate buying entity and at least two corporate supplier entities, said corporate supplier entities representing different tiers of a multi-tiered supply chain, wherein the plurality of corporate enterprises collectively form a multi-tiered value chain, and
wherein the at least one payment transaction is funded by a combination of funds received from one or more of the corporate enterprises and funds received from at least one external funding entity.

84. The system of claim 83, wherein the at least one external funding entity includes one or more dedicated external funding entities, the system further comprising instructions that when executed cause the one or more computing devices to:
receive one or more non-competitive funding proposals for funding at least a portion of the at least one payment transaction from said dedicated external funding entities;
accept at least one of the non-competitive funding proposals; and
fund at least a portion of the at least one payment transaction with the accepted funding proposals.

85. The system of claim 83, wherein the at least one external funding entity includes two or more external funding entities, the system further comprising instructions that when executed cause the one or more computing devices to:
receive one or more competitive funding proposals for funding at least a portion of the at least one payment transaction from each of the two or more external funding entities;
accept at least one of the competitive funding proposals; and
fund at least a portion of the at least one payment transaction with the accepted funding proposals.

86. The system of claim 83, wherein the at least one payment transaction is issued to at least one corporate enterprise in the value chain.

87. The system of claim 86, further comprising instructions that when executed cause the one or more computing devices to discount at least a portion of the at least one payment transaction by issuing said at least one payment transaction prior to a previously-established payment maturity date.

88. The system of claim 86, wherein the at least one payment transaction comprises two or more payments transactions issued to different corporate enterprises representing at least two different tiers of a multi-tiered value chain, the system further comprising instructions that when executed cause the one or more computing devices to:
discount the two or more payment transactions by issuing said two or more payment transactions prior to their respective previously-established payment maturity dates.

89. The system of claim 86, further comprising instructions that when executed cause the one or more computing devices to reimburse funds received from the at least one external funding entity at or after a previously-established payment maturity date.

90. The system of claim 49, further computing a netting hub engine embodied in the one or more computing devices, said netting hub engine including instructions that, when executed, cause said one or more computing devices to perform said receiving, normalizing, analyzing and netting functions.

91. The system of claim 90, wherein the data defining the two or more financial positions includes at least one of:
accounts-receivable (A/R) data;
accounts-payable (A/P) data.
loan data;
commercial debt data;
secured debt data;
unsecured debt data;
private debt data;
public debt data;
syndicated debt data;
bilateral debt data; and
financial derivative data.

92. The system of claim 90, further comprising instructions that when executed cause the one or more computing devices to:
generate at least one of one or more payment proposals and one or more netting proposals based on results from the analyzing function; and
transmit at least one of said payment proposals, netting proposals and one or more funding proposals received from at least one external funding entity to one or more payment platforms associated with at least one of the netting participants for processing,
said payment platforms including one or more of a:
banking platform,
electronic payment platform,
enterprise resource planning (ERP) platform,
electronic accounting system,
money transmitter system,
payment institution system, and
electronic invoicing system.

93. The system of claim 49, further comprising instructions that when executed cause the one or more computing devices to:
receive a selection from at least one of the netting participants, said selection identifying a collection of financial positions that includes at least one particular debt position identified by said at least one netting participant;
normalize said collection;
analyze said collection to define one or more netting cycles that result in a cancellation of the at least one particular debt position identified by the at least one netting participant; and
execute the one or more defined netting cycles to achieve a netting of said collection.

94. The system of claim 93, further comprising instructions that when executed cause the one or more computing devices to:
collect a recovery fee for defining and executing the one or more defined netting cycles that result in a cancellation of the at least one debt position.

95. The system of claim 93, wherein the selection is received on-demand.

96. The system of claim 49, wherein at least one of the netting participants includes a government entity, and wherein the two or more financial positions include at least one of a:
income tax liability,
value added tax (VAT) liability,
sales tax liability,
government fine,
government loan,
government debt,
government bond,
government grant,
foreign aid,
revenue from state-owned enterprises,
rent, concessions and royalties collected by a government from a private enterprise,
asset forfeiture,
fees generated from granting or issuing permits or licenses,
fees generated from public services or facilities, and
donations.
